(19) United States
(12) Patent Application Publication
(10) Pub. No.: US 2015/0102764 A1
(43) Pub. Date: Apr. 16, 2015

(54) WIRELESS CHARGING METHODS AND SYSTEMS FOR GAME CONTROLLERS, BASED ON POCKET-FORMING

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 14/051,170

(22) Filed: Oct. 10, 2013

(51) Int. Cl. H02J 7/02

(52) U.S. Cl. CPC H02J 7/025
USPC 320/107; 320/137

(57) ABSTRACT

The present invention provides wireless charging methods and systems for powering game controllers. The methods and systems may include one or more transmitters and one or more receivers. In some embodiments the transmitters and receivers may be embedded to game console and game controllers, respectively. In other embodiments, the transmitters and receivers may be connected as a separate device to the game console and game controllers, respectively. The method may include wireless power transmission through suitable techniques such as pocket-forming.

### CROSS-REFERENCES TO RELATED APPLICATIONS

The present invention is related to U.S. Non-Provisional patent application Ser. Nos. 13/891,430 filed May 10, 2013, entitled “Methodology For Pocket forming”; 13/925,469 filed Jun. 24, 2013, entitled “Methodology for Multiple Pocket-forming”; 13/946,082 filed Jul. 19, 2013, entitled “Method for 3 Dimensional Pocket-forming”; 13/891,399 filed May 10, 2013, entitled “Receivers for Wireless Power Transmission” and 13/891,445 filed May 10, 2013, entitled “Transmitters For Wireless Power Transmission”, the entire contents of which are incorporated herein by these references.

### FIELD OF INVENTION

The present invention relates to wireless power transmission, and more particularly to wireless charging systems and methods for game controllers, based on Pocket-forming.

### BACKGROUND OF THE INVENTION

Wireless game controllers have been known in the art since a while ago. However, few methods for providing wireless charging to these devices have been disclosed. The current methods for providing wireless charging transmission may require a charging station where the game controller may be placed so as to make physical contact with the charging station, this method may be known as magnetic induction. There may be other similar methods but they may be inconvenient and troublesome since the gamer may not be able to use the game controller while charging it.

Therefore, there is still a need for a method that allows garners to use the wireless game controllers while charging them.

### SUMMARY OF THE INVENTION

The present invention provides wireless Charging methods and systems for powering or charging game controllers. The method may include a type of transmitter which may be employed for sending Radio frequency (RE) signals to electronic devices, such as game controllers. Game controllers may also include a type of receiver embedded or attached to it for converting RF signals into suitable electricity for powering and charging themselves. The technique employed may be known as pocket-forming and may be incorporated here by reference.

A first embodiment for providing wireless power to game controllers, may be provided. In this embodiment, a transmitter may be located at the ceiling of a living room and provide wireless power to game controllers.

A second embodiment for providing wireless power to game controllers, may be provided. In this embodiment, a transmitter may be found as part of a game console. The transmitter may be internally connected to the game console and provide wireless power to game controllers.

A third embodiment for providing wireless power to game controllers, may be provided. In this embodiment, a transmitter may be found as a separate device which may be connected to a game console through suitable and well known in the art techniques such as universal serial bus (USB). The transmitter may provide wireless power to game controllers.

Numerous other aspects, features and benefits of the present invention may be made apparent from the following detailed description taken together with the drawing figures.

### BRIEF DESCRIPTION OF THE DRAWINGS

Embodiments of the present invention are described by way of example with reference to the accompanying figures, which are schematic and may not be drawn to scale. Unless indicated as representing prior art, the figures represent aspects of the present invention. The main features and advantages of the present invention will be better understood with the following descriptions, claims, and drawings, where:

FIG. 1 illustrates a component level embodiment for a transmitter in accordance with the present invention.

FIG. 2 illustrates a component level embodiment for a receiver in accordance with. the present invention.

FIG. 3 shows two embodiments for including a receiver, that can be used for pocket-forming, in a game controller in accordance with the present invention.

FIG. 4 illustrates a first embodiment for providing wireless power to game controllers, based on pocket-forming in accordance with the present invention.

FIG. 5 illustrates a second embodiment for providing wireless power to game controllers, based on pocket-forming in accordance with the present invention.

FIG. 6 illustrates a third embodiment for providing wireless power to game controllers, based on pocket-forming in accordance with the present invention.

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pockets forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting, Other embodiments may be used and/or and other changes may be made without departing from the spirit or scope of the present invention.

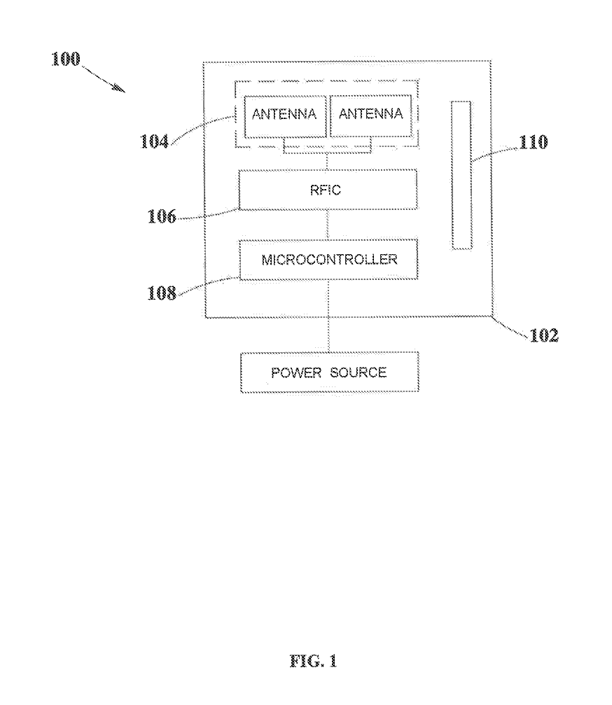

FIG. 1 shows an example of a transmitter 100 that can be used for pocket-forming. In this embodiment, transmitter 100 may he used to provide wireless power transmission. Transmitter 100 may include a housing 102 having at least two or more antenna elements 104, at least one RF integrated circuit (RFIC 106), at least one digital signal processor (DSP) or micro-controller 108, and one communications component 110. Housing 102 can be made of any suitable material Which may allow for signal or wave transmission and/or reception, for example plastic or hard rubber. Antenna elements 104 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 104 may include vertical or horizontal polarization, right hand or left hand polarization, elliptical polarization, or other suitable polarizations as well as suitable polarization combinations. Suitable antenna types may include, for example, patch antennas with heights from about ⅛ inches to about 6 inch and widths from about ⅛ inches to about 6 inch. Micro-controller 108 may then process information sent by a receiver through communications component 110 for determining optimum times and locations for pocket-forming. Communications component 110 may be based on standard wireless communication protocols which may include Bluetooth, Wi-Fi or ZigBee. In addition, communications component 110 may be used to transfer other information such as an identifier for the device or user, battery level, location or other such information. Other communications component 110 may be possible which may include radar, infrared cameras or sound devices for sonic triangulation for determining the device's position.

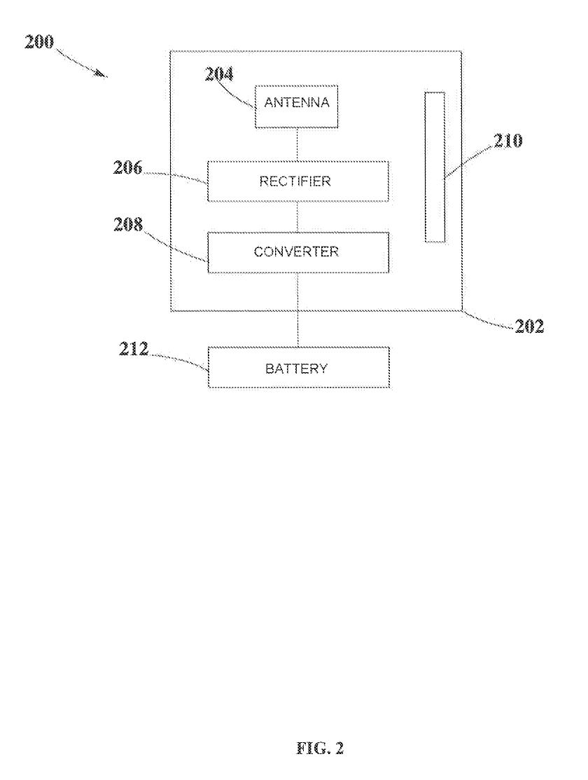

FIG. 2 shows an example of a receiver 200 that can be used for pocket-forming. In this embodiment, receiver 200 may be used for powering or charging an electronic device. Receiver 200 may also include a housing 202 having at least one antenna element 204, one rectifier 206, one power converter 208 and one or more communications component 210. Housing 202 can be made of any suitable material which may allow for signal or wave transmission and/or reception, for example plastic or hard rubber. Housing 202 may be an external hardware that may be added to different electronic equipment, for example in the form of cases, or can be embedded within electronic equipment as well. Antenna element 204 may include suitable antenna types for operating in frequency bands such as those described for transmitter 100 from FIG. 1. Antenna element 204 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a smartphone or portable gaming system. On the contrary, for devices with well-defined orientations, for example a two-handed video game controller, there might be a preferred polarization for antennas which may dictate a ratio for the number of antennas of a given polarization.

Suitable antenna types may include patch antennas with heights from about ⅛ inches to about 6 inch and widths from about ⅛ inches to about 6 inch. Patch antennas may have the advantage that polarization may depend on connectivity, i.e. depending on which side the patch is fed, the polarization may change. This may further prove advantageous as a receiver, such as receiver 200, may dynamically modify its antenna polarization to optimize wireless power transmission. Rectifier 206 may include diodes or resistors, inductors or capacitors to rectify the alternating current (AC) voltage generated by antenna element 204 to direct current (DC) voltage. Rectifier 206 may be placed as close as is technically possible to antenna element 204 to minimize losses. After rectifying AC voltage, DC voltage may be regulated using power converter 208. Power converter 208 can be a DC-DC converter which may help provide a constant voltage output, regardless of input, to an electronic device, or as in this embodiment to a battery 212. Typical voltage outputs can be from about 5 volts to about 10 volts.

In some embodiments, power converter 208 may include electronic switched mode DC-DC converters which can provide high efficiency. In such a case, a capacitor (not shown) may be included before power converter 208 to ensure sufficient current is provided for the switching device to operate. When charging an electronic device, for example a phone or laptop computer, initial high currents which can break-down the operation of an electronic switched mode DC-DC converter may be required. In such a case, a capacitor (not shown) may be added at the output of receiver 200 to provide the extra energy required. Afterwards, lower power can be provided, for example 1180 of the total initial power while having the phone or laptop still build-up charge. Lastly, a communications component 210 may be included in receiver 200 to communicate with a transmitter or to other electronic equipment. Such a communications component 210 may be based on standard wireless communication protocols which may include Bluetooth, WI-Fi or ZigBee similar to communications component 110 from transmitter 100.

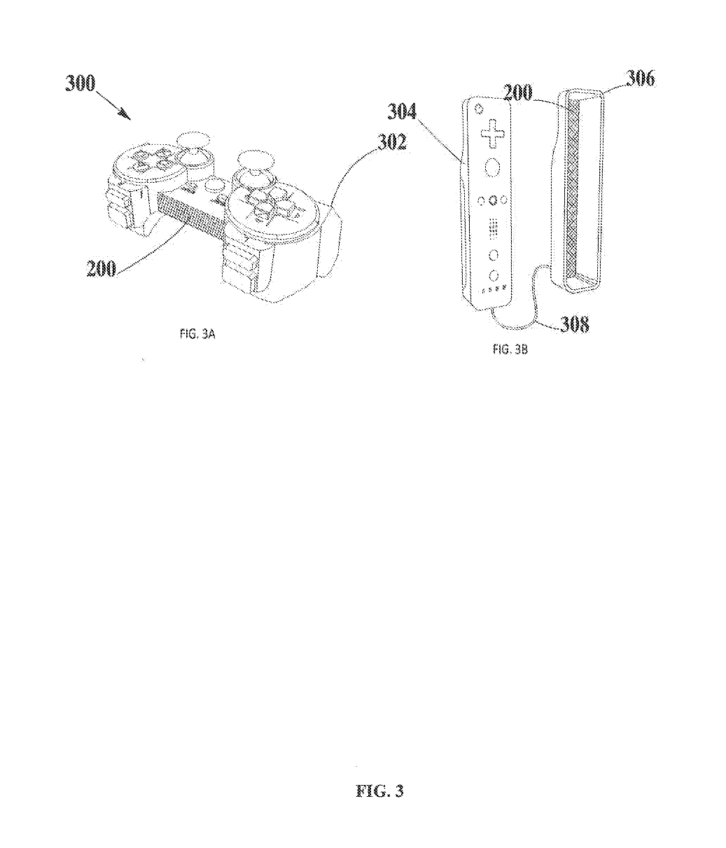

FIG. 3 illustrates two embodiments including a receiver 200 that can he used for pocket-forming in game controllers 300. FIG. 3A then shows a first embodiment where game controller 302 may include a receiver 200, as the one described in FIG. 2, embedded in its front side. Receiver 200 may include an array of antenna elements 204 strategically distributed on the grid area shown in FIG. 3A. The number and type of antenna elements 204 may be calculated according to the game controller's design.

FIG. 3B shows a second embodiment where game controller 304 may include receiver 200, as the one described in FIG. 2. However, in this embodiment, game controller 304 may need an additional case 306 to provide wireless power to game controller 304. Case 306 may be made out of plastic rubber or any other suitable material for cases, and it may include an array of antenna elements 204 located on the back side of case 306 which number and type may be calculated according to the game controller design, as shown in FIG. 3B. Case 306 may also be connected to game controller 304 through a cable 308, or in other embodiments game controller 304 may just be hooked up to case 306 (not shown), to provide wireless power.

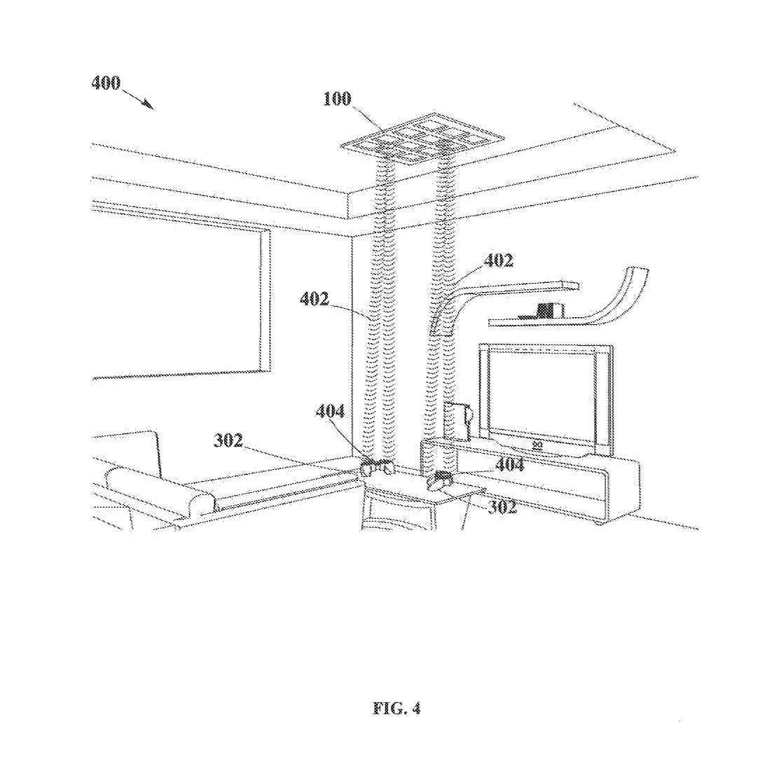

FIG. 4 illustrates a first embodiment for providing wireless power transmission 400 to game controllers 300, using pocket-forming. Transmitter 100 may be located at the ceiling of a living room pointing downwards, and may transmit controlled Radio RF waves 402 which may converge in 3-d space. These Radio frequencies (RF) waves 402 may be controlled through. phase and/or relative amplitude adjustments to form constructive and destructive interference patterns (pocket-forming). Pockets of energy 404 may be formed at constructive interference patterns and can be 3-dimensional in shape whereas null-spaces may be generated at destructive interference patterns. A receiver 200, embedded or attached to game controllers 300, may then utilize pockets of energy 404 produced by pocket-forming for charging or powering an electronic device, for example a game controller 302 or game controller 304, and thus effectively providing wireless power transmission 400.

In an embodiment, transmitter 100 may include a housing 102 where at least two or more antenna elements 104, at least one RF integrated circuit (RFIC 106), at least one digital signal processor (DSP) or micro-controller 108, and one communications component 110 may be included. Transmitter 100 may also include a local oscillator chip for converting alternating current (AC) power to analog RIF signals. Such RF signals may firstly be phase and gain adjusted through an RFIC 106 proprietary chip, and then converted to RF waves 402 via antenna elements 104. On the other hand, receiver 200 may include a housing 202 where at least one antenna element 204, at least one rectifier 206 and at least one power converter 208 may be included. Receiver 200 may communicate with transmitter 100 through short RF waves 402 or pilot signals sent through antenna elements 204. In some embodiments, receiver 200 may include an optional communications device for communicating on standard wireless communication protocols such as Bluetooth, Wi-Fi or Zigbee with transmitter 100. In some embodiments, receiver 200 may be implemented externally to electronic devices in the form of cases, e.g. camera cases, phone cases and the like which may connect through suitable and well known in the art techniques such as universal serial bus (USB). In other embodiments, receiver 200 may be embedded within electronic devices.

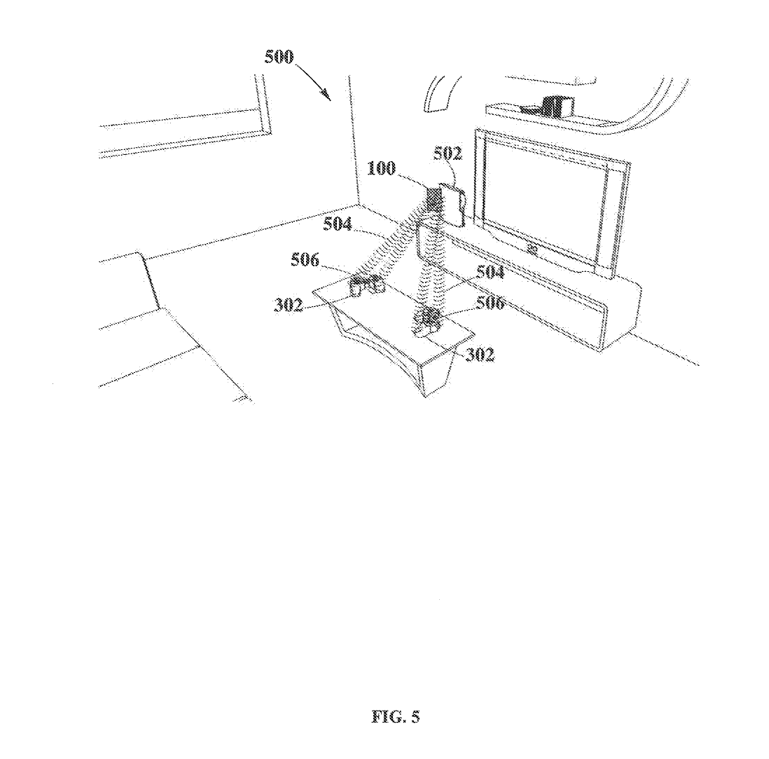

FIG. 5 illustrates a second embodiment for providing wireless power transmission 500 to game controllers 300, based on pocket-forming. In this embodiment, transmitter 100 may be included as part of the game console 502, and may be positioned as an attachment of the cover of game console 502, as shown in FIG. 5. Transmitter 100 may be internally connected to game console 502 and produce controlled RF waves 504. Controlled RF waves 504 may then create pockets of energy 506 on receiver 200, which may be embedded in game controller 302. Game controller 302 may then utilize pockets of energy 506, produced by pocket-forming, for charging or powering itself.

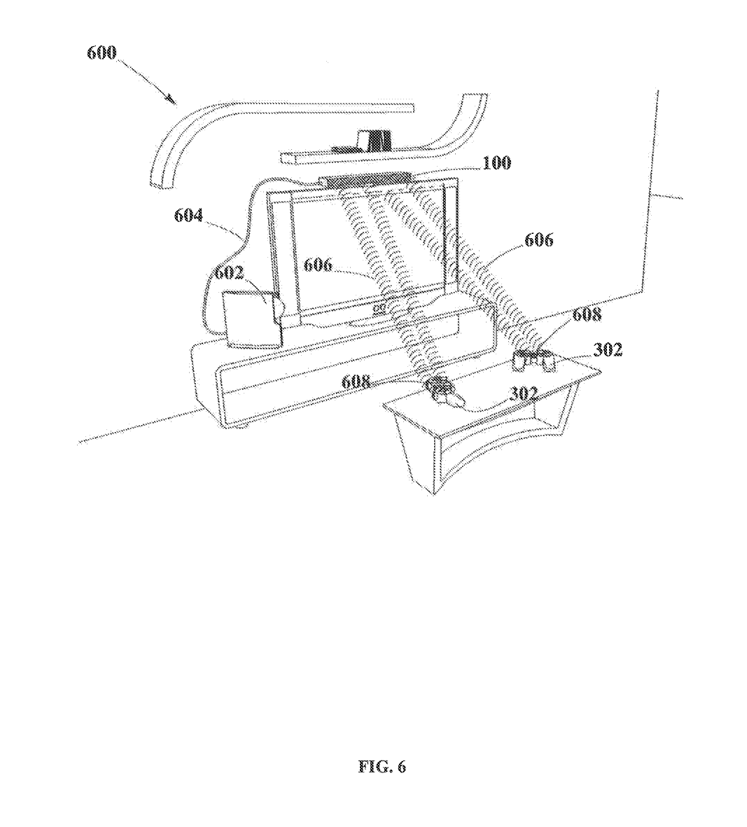

FIG. 6 illustrates a third embodiment for providing wireless power transmission 600 to game controllers 300, based on pocket-forming. In this embodiment, transmitter 100 may be included as a separate device and may be connected to game console 602 through suitable and well known in the art techniques such as a USB cable 604. Transmitter 100 may then obtain from game console 602 the power necessary to produce controlled RF waves 606 and send them to game controllers 302 so as to produce pockets of energy 608 on receiver 200, which may be embedded in game controller 302. Game controller 302 may then utilize pockets of energy 608, produced by pocket-forming, for charging or powering itself.

While the foregoing disclosure, system configuration, methods and various aspects and embodiments have been disclosed herein, other aspects and embodiments are contemplated. The various aspects and embodiments disclosed herein. are for purposes of illustration and are not intended to be limiting, with the true scope and spirit being indicated, the invention should be construed to include everything within the scope of the appended claims and equivalents.

Having thus described the invention, we claim;

1. A method for wireless charging of a game controller, comprising:
connecting a pocket-forming transmitter to a power source;
generating RF waves from a RF circuit embedded within the transmitter;
Controlling the generated RF waves with a digital signal processor in the transmitter;
transmitting the RF waves through antenna elements connected to the transmitter; and
capturing the RF waves forming pockets of energy in 3-D space at a receiver with antenna elements connected to the game controller to convert the pockets of energy into a DC voltage for charging or powering a battery of the gamer controller.

2. The method for wireless charging of a game controller of claim 1, wherein the transmitter is mounted in a central location within a gaming room and the receiver is mounted on or connected to the game controller.

3. The method for wireless charging of a game controller of claim 1, further includes the steps of communicating a power level of the battery and communicating a location of the game controller within a gaming room.

4. The method for wireless charging of a game controller of claim 1, wherein the transmitter and receiver each include communication circuitry for communicating information between the transmitter and receiver.

5. The method for wireless charging of a game controller of claim 1, wherein the pocket-forming transmitter is mounted on a ceiling of a game room or mounted on a game console within the game room and wherein the transmitter mounted on the ceiling or mounted on the game console are connected to a power source.

6. The method for wireless charging of a game controller of claim 1, wherein receiver and antenna elements are mounted to the game controller or the receiver and the antenna elements are mounted on a case connected electrically to the game controller.

7. The method for wireless charging of a game controller of claim 7, wherein the case is made out of plastic, rubber or any other suitable material with the antenna elements are mounted on the backside of the case with the number and type of elements are predetermined according to the game controller design.

8. The method for wireless charging of a game controller of claim 1, wherein the controlled RF waves are controlled through phase and relative amplitude adjustments to form the constructive interference patterns that result in the pockets of energy at the receiver for the game controller.

9. The method for wireless charging of a game controller of claim 4, wherein the communication circuitry uses standard wireless communication protocols such as Bluetooth, Wi-Fi, Zi ghee or FM radio between the transmitter and receiver.

10. The method for wireless charging of a game controller of claim 1, wherein the antenna elements in the transmitter and receiver operate in the frequency bands of 900 MHz, 2.4 GHz or 5.8 GHz.

11. The method for wireless charging of a game controller of claim 1, further includes the step of generating multiple pockets of energy from the pocket-forming transmitter to power or charge multiple game controllers within a predetermined distance from the transmitter.

12. The method for wireless charging of a game controller of claim 1, wherein the receiver is external to the game controller in the form of a case that is a camera case, phone case or other type of external case connected to the game controller through an universal serial bus.

13. The method for wireless charging of a game controller of claim 1, further comprising the step of communicating between the receiver and the transmitter through the communication signals or pilot signals on conventional wireless communication protocols including Bluetooth, Wi-Fi, Zigbee or FM radio signals.

14. The method for wireless charging of a game controller of claim 1, wherein the communication signals sent by the receiver provide times and locations for transmitter pocket-forming and the convergence of pockets of energy in 3-D space to predetermined receivers of game controllers within a predetermined distance from the transmitter in a game room.

15. A wireless device for transmission of power to a game controller, comprising:
a pocket-forming transmitter for emitting power RF waves to form pockets of energy to converge in 3-d space connected to a power source in a game room; and
a receiver embedded or attached to the game controller for receiving and converting the pockets of energy to a DC voltage for charging or powering a battery of the game controller.

16. The wireless device for transmission of power to a game controller of claim 15, wherein the pocket-forming transmitter is located on the ceiling of the game room pointing downward toward the receiver for charging or powering the battery of the game controller.

17. The wireless device for transmission of power to a game controller of claim 15, wherein the pocket-forming transmitter is internally connected to the game console and the transmitter is connected to the game console power source to produce the power RF waves.

18. The wireless device for transmission of power to a game controller of claim 15, wherein the receiver is embedded or attached to the game controller.

19. The wireless device for transmission of power to a game controller of claim 15, wherein the transmitter is a separate device connected to a game console through a cable or USB cable for a power source.

20. An apparatus for wireless power transmission to a game controller, comprising:
a battery connected to the game controller;
a pocket-forming transmitter having at least two or more antenna elements, at least one RF integrated circuit, at least one digital signal processor or micro-controller and a communication circuit for generating controlled RF waves to form pockets of energy consisting of constructive interference patterns of the generated RF waves to converge in 3-D space at predetermined locations; and
a receiver embedded or attached to the game controller having at least one antenna element, at least one rectifier, at least one power converter and a communication circuit for communicating with the transmitter the exact location and power requirements of the game controller for receiving the pockets of energy converging in the 3-D space at the receiver to charge or power the game controller,

21. The apparatus for wireless power transmission to a game controller of claim 20, wherein the communication circuitry of the transmitter and receiver utilizes Bluetooth, infrared, Wi-Fi, FM radio or Zigbee signals for the communication protocols between the receiver and the transmitter.

22. The apparatus for wireless power transmission to a game controller of claim 20, wherein the transmitter further includes flat antenna elements, patch antenna elements with heights from approximately ⅛ inches to about 6 inch and widths from approximately ⅛ inches to about 6 inch.

23. The apparatus for wireless power transmission to a game controller of claim 20, wherein the antenna elements of the transmitter operate in frequency bands of 900 MHz, 2.4 GHz or 5.8 GHz.

24. The apparatus for wireless power transmission to a game controller of claim 20, wherein the antenna elements of the transmitter operate in independent frequencies that allow a multichannel operation of pocket-forming in a single array, pair array, quad array or other suitable arrangement for powering the game controller within a gaming room.

25. The apparatus for wireless power transmission to a game controller of claim 20, wherein the antenna elements of the transmitter include polarization of vertical pole, horizontal, circularly polarized, left hand polarized, right hand polarized, elliptical. or a combination of polarizations to maximize the transmission of pockets of energy to predetermined game controllers at optimum times and locations within a gaming room.
